(19) United States
(12) Patent Application Publication
(10) Pub. No.: US 2020/0026279 A1
(43) Pub. Date: Jan. 23, 2020

(54) SMART NEIGHBORHOOD ROUTING FOR AUTONOMOUS VEHICLES

(71) Applicant: Ford Global Technologies, LLC, Dearborn, MI (US)

(72) Inventors: Kevin Rhodes, Dearborn, MI (US); Mahmoud Abdelhamid, Canton, MI (US); Chad Bednar, Royal Oak, MI (US)

(73) Assignee: Ford Global Technologies, LLC, Dearborn, MI (US)

(21) Appl. No.: 16/040,930

(22) Filed: Jul. 20, 2018

(51) Int. Cl. G05D 1/00; G01C 21/34

(52) U.S. Cl. CPC G05D 1/0088; G01C 21/3476; G05D 2201/0213; G05D 2201/0212; G01C 21/3484

(57) ABSTRACT

Systems, methods, and computer-readable media are disclosed for smart neighborhood routing for autonomous vehicles. Example methods may include determining, by one or more computer processors coupled to at least one memory, a first set of inputs indicative of real estate locations, determining a set of real estate options based at least in part on the first set of inputs, the set of real estate options comprising a first real estate option, determining that the first real estate option is selected for viewing by a user, and determining a route from a first location to a second location, the second location associated with the first real estate option, wherein the route includes at least one stopping point.

### TECHNICAL FIELD

The present disclosure relates to systems, methods, and computer-readable media for smart neighborhood routing for autonomous vehicles.

### BACKGROUND

Users may be interested in finding and visiting various real estate locations. For example, a user may be interested in buying or renting a house and may desire to visit the house. In addition, the user may desire to view locations of interest, such as parks or other locations, that may be near the house. However, the user may not be aware of nearby locations of interest. In addition, the user may desire to view or visit real estate properties without advance scheduling.

### BRIEF DESCRIPTION OF THE DRAWINGS

FIG. 1A is a schematic illustration of an example implementation of smart neighborhood routing for autonomous vehicles in accordance with one or more embodiments of the disclosure.

FIG. 1B is a schematic illustration of an example implementation of facilitating access to a real estate option in accordance with one or more embodiments of the disclosure.

FIG. 1C is a schematic illustration of an example implementation of a neighborhood tour for autonomous vehicles in accordance with one or more embodiments of the disclosure.

FIG. 2 is an example process flow for a method of generating a neighborhood tour for autonomous vehicles in accordance with one or more embodiments of the disclosure.

FIG. 3 is an example process flow for a method of managing autonomous vehicle modes during a neighborhood tour in accordance with one or more embodiments of the disclosure.

FIG. 4 are schematic illustrations of example user interfaces for smart neighborhood routing for autonomous vehicles in accordance with one or more embodiments of the disclosure.

FIG. 5 is a schematic illustration of an example implementation of presentation of relevant local information in accordance with one or more embodiments of the disclosure.

FIG. 6 is a schematic illustration of an example autonomous vehicle in accordance with one or more embodiments of the disclosure.

FIG. 7 is a block diagram of an example computer architecture in accordance with one or more embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

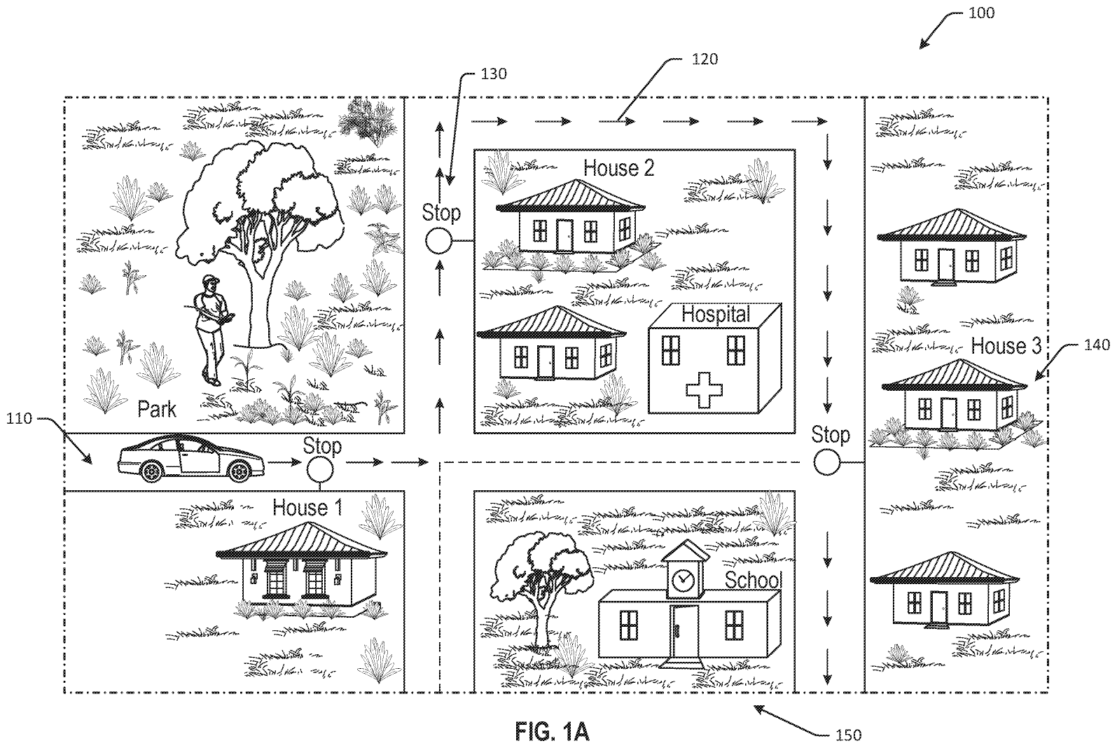

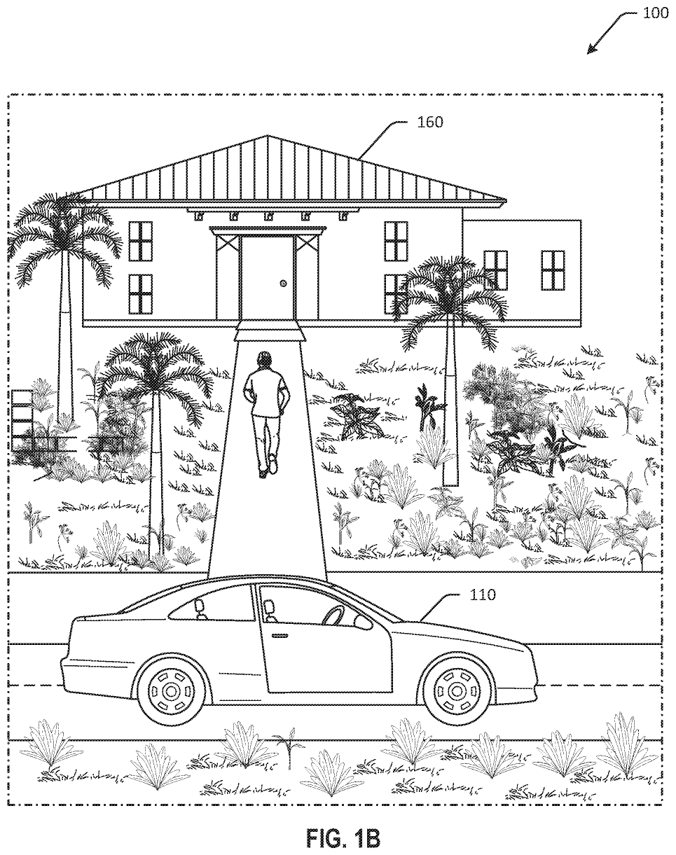

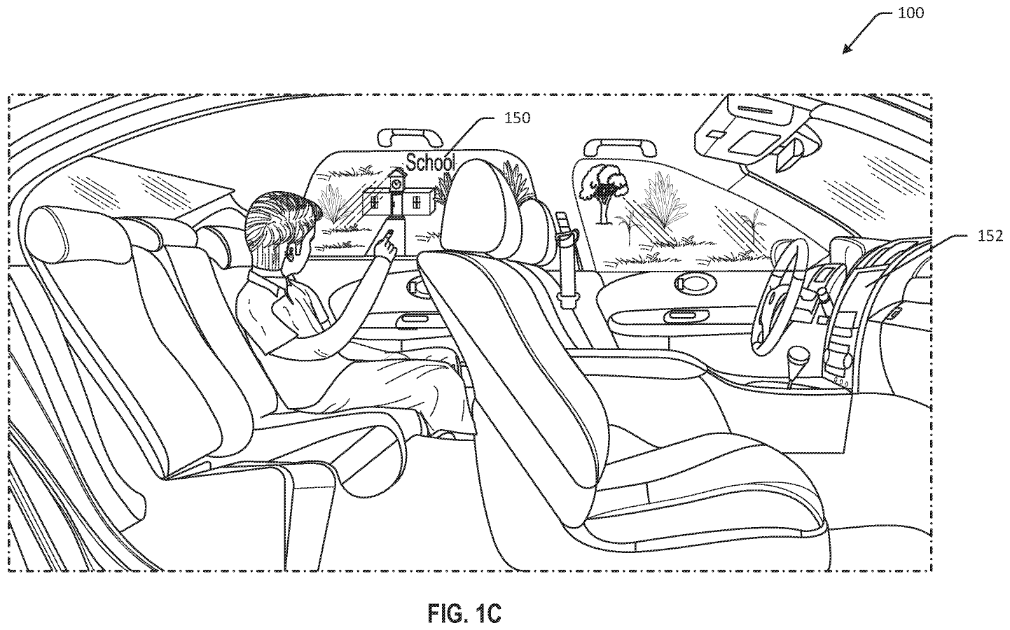

FIG. 1 is a schematic illustration of an example implementation 100 of smart neighborhood routing for autonomous vehicles in accordance with one or more embodiments of the disclosure.

Autonomous vehicles can be used to transport users to desired destinations. However, in some instances, users may not have a specific destination in mind, and may instead desire to scan specific geographical areas to collect specific information. For example, a user may desire to rent or buy a house, office, or other real estate. To find information related to specific locations, users may ask real estate agents, friends, and/or search on the internet. Users may also drive themselves around a neighborhood to get a feel for the surroundings.

Embodiments of the disclosure include systems and methods, as well as autonomous vehicles, that include functionality allowing autonomous vehicles to generate routing, select real estate options, identify locations of interest, and/or provide tours of real estate locations, neighborhoods, and so forth. Accordingly, embodiments of the disclosure may automatically generate tours for users without specific selections of locations, and/or may provide options of available real estate for users to select from.

Certain embodiments may include autonomous vehicles that assist in buying or renting homes or offices. For example, one or more remote servers, or an autonomous vehicle and/or user device, may be used to query a user (who may or may not be an occupant of an autonomous vehicle) for inputs such as a desire to rent or buy, real estate type (e.g., office, condominium, house, etc.), price range, roam radius(e.g., a distance from a current location or a designated location within which the user is interested in viewing real estate, etc.), back road/highway selection, crime rate, and/or public schools rating. Roam radius may specify the maximum range that the vehicle is to travel away from its starting location. Such inputs may be used to determine routing and/or candidate for real estate for the user to visit.

The back road/highway selection may be used to limit the roaming path to a combination of highway and back roads or just to back roads. Crime region avoidance may be selected as a rating value, which may cause the roaming path to avoid areas with crime rate index higher than the user selected value. Cartesian direction may be specified as north, east, south, and/or west to limit the roam path to this quadrant of the roaming circle, which may be defined by the roam radius. A path dimension value may be specified to determine how meandering the roam path will be.

The user may also set a trip duration, which may be the maximum length of time for the trip. The user may also specify a Cartesian direction from the origin for the trip. For example, the user could request to go north from the origin depending upon which areas the user would like to explore.

In some embodiments, inputs may include a machine learning component, which may store driver historical preference and/or rating for similar places. Such performance and/or rating information may be compared to average ratings and/or availabilities from one or more online sources. The comparison may be used with machine learning to determine other real estate options that the user may like.

Machine learning aspects may be used to refine performance of the system over time. For example, machine learning may incorporate a driver historical preference and/or ratings of various real estate properties that one or more users have viewed, availability and/or ratings from third party sources, such as real estate listing services, and so forth.

Before, during, or after the autonomous vehicle journey is started or ordered, a machine learning algorithm may be used to generate a set of all the available real estate options. The user and/or occupant may select a route based on several routing options (e.g., shortest path, fastest path, greenest path, etc.). After the route is selected (and optionally no emergency is detected), the autonomous vehicle journey may begin.

Some embodiments may include functionality and/or integration with one or more online real estate systems, which may allow a user to browse real estate listings in the respective online real estate systems on the user's computer, phone, and/or in a vehicle connected system or other device, and identify real estate properties which the user is interested in. Information about the selected property or set of properties may be reviewed and/or analyzed to identify local schools, shopping centers, public facilities, parks, hospitals, and/or other points or locations of interests within a predetermined distance of the selected properties. The analyzed data may be used to automatically prepare a tour of the area.

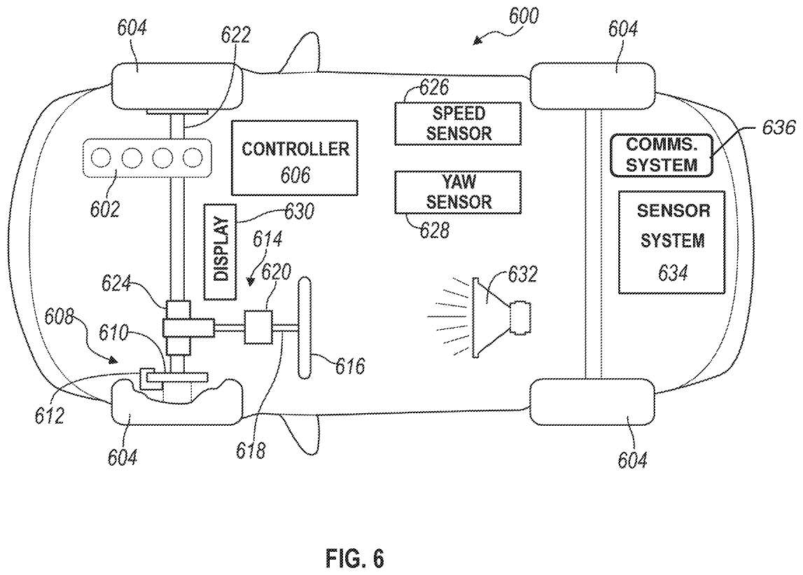

The tour information, which may include an ordered list of destinations (e.g., real estate locations selected by a user, points or locations of interest, local event locations, etc.), a routing and/or mapping of a route, and/or other data may be sent to (or generated by) the autonomous vehicle. The autonomous vehicle may then take the user to the property or properties of interest, one at a time, and at some or all properties display relevant information about the current property on the display of the vehicle or the user's device. Audio information may also be provided using an audio system of the autonomous vehicle (e.g., as illustrated in FIG. 6) and/or an audio component of the user's device, such as a smartphone. As the autonomous vehicle drives to the next property, or after the user has viewed the property, the autonomous vehicle may proceed on a custom guided tour of the surrounding area while displaying relevant information such as school ratings, property mileage, relevant annual events such as fairs or farmers markets, and/or other relevant information. In some embodiments, sellers of real estate may propose or select points of interest near their properties which potential buyers may opt to add to their tour. In some instances, embodiments of the disclosure may be implemented without additional hardware costs.

In FIG. 1A, an autonomous vehicle 110 may drive to a first real estate property (House 1), and may stop and wait for a user to view the property. After the user returns, the autonomous vehicle 110 may proceed along a route 120 to a second stop 130, which may be at a second real estate property (House 2), at which the user may exit the autonomous vehicle 110 and tour or view the second real estate property. The autonomous vehicle 110 may then proceed along the route 120 to a third stop 140, which may be at a third real estate property (House 3), at which the user may exit the autonomous vehicle 110 and tour or view the third real estate property. The autonomous vehicle 110 may then proceed along the route 120, which may go past a school 150 or another location of interest, so that the user can determine a proximity between one or more of the real estate properties and the school 150, and so forth.

As the autonomous vehicle 110 drives along the route 120, information related to locations of interest may be presented at one or more displays and/or audio systems of the autonomous vehicle 110 and/or the user's device. For example, information related to the park, hospital, school, etc. illustrated in the example of FIG. 1A may be presented. The information may be sourced from online resources, such as third party real estate data providers, maps, and other sources, and may be downloaded or streamed by the autonomous vehicle for presentation at a display system of the autonomous vehicle. In some embodiments, the information may be downloaded and/or streamed by a user device of the user, and may be presented at a display of the user device instead of, or in addition to, a display in the vehicle. In such instances, one or both the vehicle and the user device may communicate with one or more remote servers.

To generate the route 120, one or more computer processors coupled to at least one memory of a computer system (such as one or more remote servers, the autonomous vehicle 110, etc.) may determine a first set of inputs indicative of desired real estate. The one or more computer processors may correspond to the processor(s) 802 illustrated in FIG. 8 and/or the controller 604 of the vehicle illustrated in FIG. 6. In some embodiments, various operations may be performed by either or both the vehicle itself (e.g., a controller of the vehicle) or one or more remote servers, such as that illustrated in FIG. 8.

In FIG. 1A, the user may desire to view houses to buy. Accordingly, the user may request to see real estate options and/or locations of houses that are available to buy or are for sale. The computer processor(s) may determine a set of real estate options based at least in part on the first set of inputs. For example, the computer processor(s) may query one or more databases or online real estate systems. The set of real estate options may include a first real estate option, such as House 1, a second real estate option, such as House 2, a third real estate option, such as House 3, and so forth. The user may select one or more of the options. Selections may be made using a display and/or microphone of the autonomous vehicle and/or using a mobile application executing on a user device, such as a smartphone.

The computer processor(s) may determine that the first real estate option (House 1) is selected for viewing by the user, and may determine a route from a current location to a first location of the first real estate option. For example, the user may be at his or her home (current location), and the computer processor(s) may determine a route from the current location to House 1. Route determinations may include retrieval and analysis of current traffic data and/or distance to destination determinations to determine an optimal route and/or order of real estate locations to visit. In some embodiments, the user may arrange the selected real estate options in a desired order.

In some embodiments, a user may make selections of real estate properties prior to entering the autonomous vehicle 110. In such instances, the computer processor(s) may determine the current location of the user, which may be a pick up location for the user, and may cause the autonomous vehicle 110 to drive to the current location to pick up the user.

The user may indicate whether or not the user is interested in a tour of a neighborhood of the real estate option, such as House 1. A neighborhood tour may include driving by and/or stopping at various locations of interest, as described herein. If the user is interested, the computer processor(s) may determine that the user is interested in a neighborhood of the first location (e.g., location of House 1 in this example), and may generate a neighborhood tour routing for the neighborhood that surrounds House 1, which may include points or locations of interest, which may be based on historical information associated with prior tours and/or the user. The neighborhood tour routing may include identified locations of interest, such as schools (e.g., if the user has children, etc.), parks, public facilities, shopping malls, and so forth. The computer processor(s) may cause the autonomous vehicle 110 to drive along the neighborhood tour routing, which may or may not include route 120.

In an example process flow, a determination may be made by the autonomous vehicle and/or one or more connected servers as to whether a user or occupant of the autonomous vehicle has provided any inputs. If not, the process may end. If so, then a determination may be made by the autonomous vehicle and/or one or more connected servers as to whether any machine learning inputs are available. If not, then the process may end. If so, then a determination may be made by the autonomous vehicle and/or one or more connected servers as to whether any other real estate options are available. If so, then the options may be presented at a user device or a display of the autonomous vehicle. If not, then the process may end. After the options are displayed, a determination may be made by the autonomous vehicle and/or one or more connected servers as to whether a preferred route has been selected. This determination may be made based at least in part on whether a user has selected a preferred route and/or selected a preferred route type, such as avoid highways, avoid tolls, fastest route type, greenest route type, shortest route type, etc. If not, then the process may end. If so, then the autonomous vehicle may begin driving along the selected route.

For example, the computer processor(s) may determine a route from a current location to a first location of the first real estate option. The vehicle may autonomously drive from the current location to the first location. The computer processor(s) may cause the autonomous vehicle to wait at the first location for a predetermined length of time (such as a length of time indicated by the user for viewing the property) and may cause the vehicle to autonomously drive from the first location to the second location of the next property in the tour.

While in operation, a continuous process may be executed to make a determination by the autonomous vehicle and/or one or more connected servers as to whether an emergency has occurred. This determination may be made based at least in part on whether the user has indicated the occurrence of an emergency, for example, using the user's device and/or the display at the vehicle. If not, the autonomous vehicle may continue driving along the path. If so, the autonomous vehicle may cancel the real estate tour and may return to a pickup location or a designated emergency location, such as a home, hospital, or the like.

The neighborhood tour may include an abort option presented at the display of the vehicle and/or at the user device that allows the user to end the tour at their pleasure or in the event of an emergency. The display of the vehicle and/or the user device may include an icon that once selected by the user ends the tour. In one embodiment, in response to a request to abort, the tour may be ended and the vehicle may plot a second route back to the origin. The second route may be the most efficient route between the vehicle's current location and the origin. The most efficient route may be the shortest distance or the shortest time. The vehicle then executes the second route by generating steering, powertrain, and braking commands in order to autonomously drive the vehicle along the second route.

FIG. 1B is a schematic illustration of an example implementation of facilitating access to a real estate option in accordance with one or more embodiments of the disclosure. For example, a first real estate option 160 may be House 1 of FIG. 1A. Computer processor(s) of the autonomous vehicle 110 or one or more servers may facilitate access to the first real estate option 160 for the user. To facilitate access, the computer processor(s) may use an automated schedule assistant, generate a message for a real estate agent, determine an access code, provide a key or other physical access device, and/or other suitable means of facilitating access. In an example embodiment, the autonomous vehicle 110 and/or one or more remote servers may automatically schedule and/or contact a user device of a real estate agent associated with the first real estate option 160. The real estate agent contact information may be determined using a real estate listing for the first real estate option 160. The autonomous vehicle 110 and/or the remote servers may automatically send a message and/or voice communication requesting access to the first real estate option at a particular time. The user may then be granted access to the real estate property. For example, the agent may reply to a message or send a separate message or indication to the vehicle or remote server with access data (e.g., passcode, QR code, bar code, audible, etc.) to unlock the house or other property. The access data may then be forwarded, printed, displayed, etc. to the user and/or the user device.

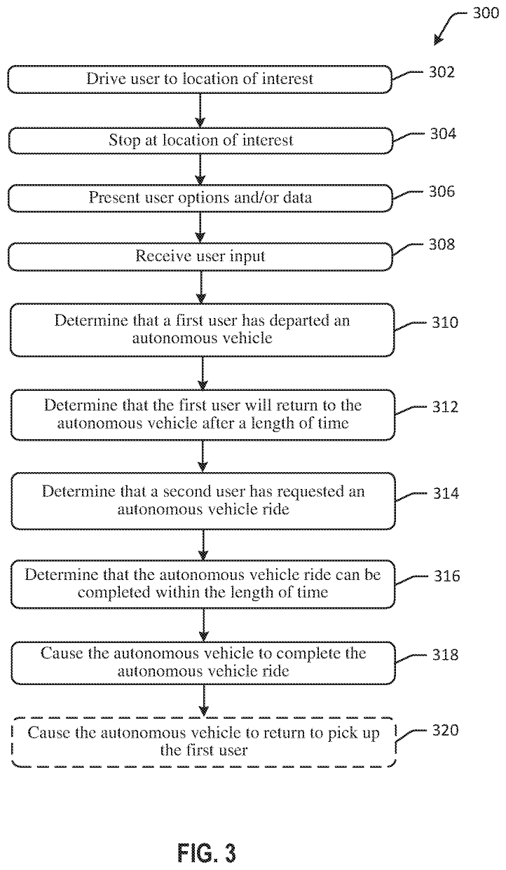

Once the user accesses the first real estate option 160, the user may desire to spend some time viewing the property. As discussed in more detail with respect to FIG. 3, in some embodiments, the autonomous vehicle 220 may wait for the user, while in other embodiments, the autonomous vehicle 220 may leave the first real estate option 160 and return when the user is done and/or at a designated time.

For example, the computer processor(s) determine that the user has departed the autonomous vehicle 220 at the first location or first real estate option 160 (e.g., by detecting that the door was opened and closed, by receiving an indication from the user that the user would like to tour the property, by a mobile device of the user detecting movement indicative of a user walking and sending an indication of such to the vehicle or remote server, etc.), and may determine that the user will not return to the autonomous vehicle 110 for a length of time. For example, the user may indicate that the user will be viewing the property for 15 minutes, based on historical information (e.g., information associated with the property, other property, and/or the user), and/or based on the tour (e.g., time allocated to the property in the tour). Accordingly, the computer processor(s) may cause the autonomous vehicle 110 to be available for ridesharing (e.g., in a ridesharing mode) or for another purpose during the length of time. For example, because the user does not need the autonomous vehicle 110 during the length of time, the autonomous vehicle 110 may be used for other tasks or purposes. In some embodiments, the user may be given a time limit, such as 20 minutes, after which the autonomous vehicle 110 may leave, and another autonomous vehicle or the same autonomous vehicle 110 may return to pick up the user when the user has completed viewing the property, as discussed with respect to FIG. 3.

In another example, the computer processor(s) may determine that the user has departed an autonomous vehicle 110 at the first location, and may determine that the user will return to the autonomous vehicle 110 within a length of time. For example, the user may indicate that the user will be done viewing the property within 10 minutes, and as a result, the computer processor(s) may cause the autonomous vehicle 110 to remain at or near the first location for the length of time. For example, the autonomous vehicle 110 may drive around the nearby area if parking is not possible.

FIG. 1C is a schematic illustration of an example implementation of a neighborhood tour for autonomous vehicles in accordance with one or more embodiments of the disclosure.

In the example of FIG. 1C, the autonomous vehicle 110 may drive the user to nearby locations of interest, such as the school 150 of FIG. 1A, and may present additional information as the user views the location and/or the vehicle drives past the location of interest. The additional information may be audio and/or visual content that may be downloaded or streamed from one or more third party services. For example, content related to a particular neighborhood and/or location may be associated with a real estate location based at least in part on an address, a zip code, GPS coordinates, a city, and/or other location identifying information. The content may be presented using the vehicle's display 152 and/or audio system, or the user device's display and/or audio system.

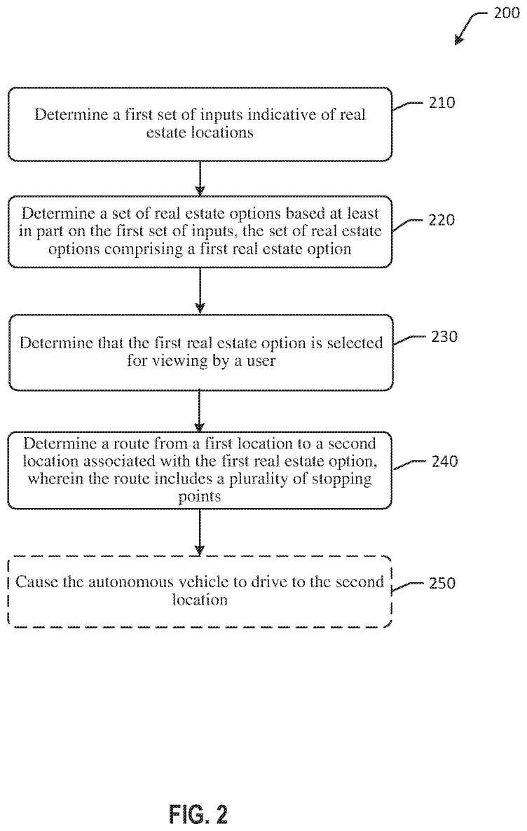

FIG. 2 is an example process flow 200 for a method of generating a neighborhood tour for autonomous vehicles in accordance with one or more embodiments of the disclosure.

At block 210 of the process flow 200, one or more computer processors of a remote server and/or an autonomous vehicle may execute computer-executable instructions stored on memory to determine a first set of inputs indicative of real estate locations. For example, the computer processor(s) may receive a request to identify available real estate options. The request may be received from a user device and/or an autonomous vehicle, and may include information such as whether houses or apartments are desired, whether purchase or rent is desired, an area or location to search, and so forth. The user may input selections using a touchscreen, for example, of the user device and/or autonomous vehicle. The user inputs may be received by the computer processor(s) and may be indicative of desired real estate locations, types, purchase structure (e.g., rent or buy, etc.).

At block 220 of the process flow 200, one or more computer processors of a remote server and/or an autonomous vehicle may execute computer-executable instructions stored on memory to determine a set of real estate options based at least in part on the first set of inputs, the set of real estate options comprising a first real estate option. For example, the computer processor(s) may query one or more real estate listing services or databases to determine real estate options that satisfy the criteria in the request. A set of real estate options that satisfy the criteria of the request may be determined based at least in part on results provided by the real estate listing services and/or results from querying one or more databases. The set of real estate options may be presented at a display of the autonomous vehicle and/or the user device, and may be selectable by the user. For example, the user may select options that are of interest to the user. The user may select a first real estate option of the set of real estate options and may indicate that the user would like to tour and/or visit the property and/or surrounding neighborhood.

At block 230 of the process flow 200, one or more computer processors of a remote server and/or an autonomous vehicle may execute computer-executable instructions stored on memory to determine that the first real estate option is selected for viewing by a user. For example, after the user makes a selection of the first real estate option at the display of the autonomous vehicle and/or the user device, the computer processor(s) may determine that the first real estate option is selected or has been selected by the user for viewing.

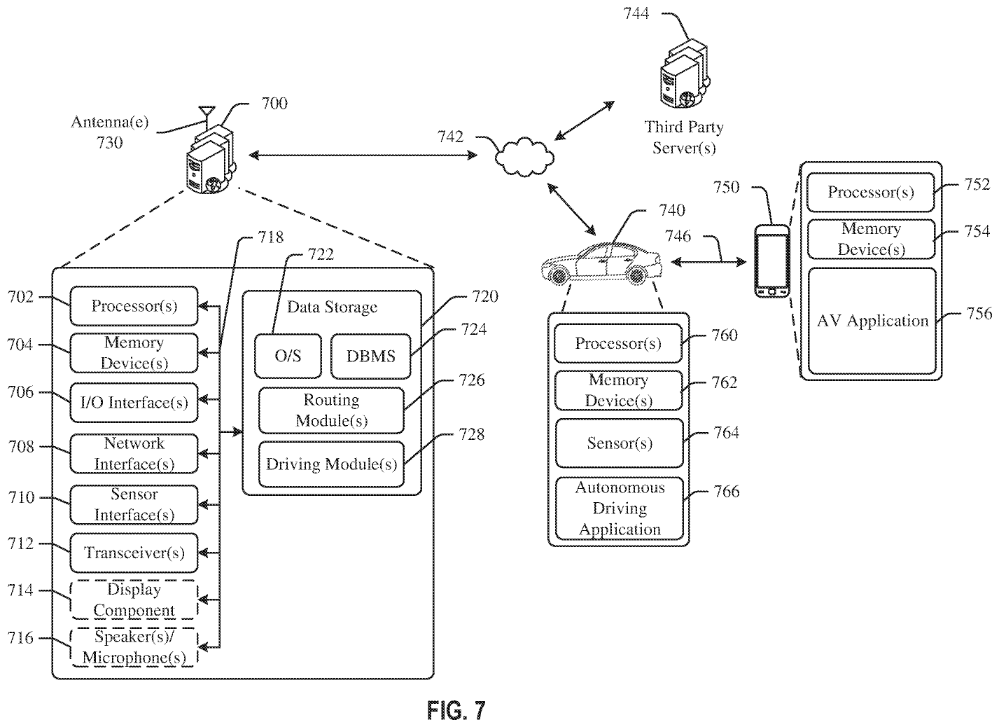

At block 240 of the process flow 200, one or more computer processors of a remote server and/or an autonomous vehicle may execute computer-executable instructions stored on memory to determine a route from a first location to a second location associated with the first real estate option, wherein the route includes a plurality of stopping points. For example, the computer processor(s) may determine map data, which may include traffic data in real-time, to determine a route from a current location of the autonomous vehicle to the location of the first real estate option. The routing may be determined based at least in part on current or historical user preferences, as associated with a user profile. For example, the user may indicate that they would like to avoid highways or certain neighborhoods. To drive along the route, the autonomous vehicle may include one or more controllers (illustrated for example in FIG. 6) locally that use real-time determinations and/or calculations as to road conditions, etc. that are detected by sensors (e.g., yaw sensor data, pitch data, computer vision feedback, etc.). Operation of the vehicle is described in more detail with respect to FIGS. 6-7.

At optional block 250 of the process flow 200, one or more computer processors of a remote server and/or an autonomous vehicle may execute computer-executable instructions stored on memory to cause the autonomous vehicle to drive from the current location to the first location. The autonomous vehicle may be sent a command by a remote server, or may initiate a trip on its own, to drive along the route from the current location to the first real estate option location.

FIG. 3 is an example process flow 300 for a method of managing autonomous vehicle modes during a neighborhood tour in accordance with one or more embodiments of the disclosure. For example, continuing the example of FIG. 2, once the autonomous vehicle arrives at the first real estate option location, the user may leave the autonomous vehicle and may view or tour the property.

At block 302 of the process flow 300, one or more computer processors of a remote server and/or an autonomous vehicle may execute computer-executable instructions stored on memory to drive a user to a location of interest. For example, a user may input a first location of interest using a user device or user interface at an autonomous vehicle. The autonomous vehicle may drive the user to the location of interest.

At block 304 of the process flow 300, one or more computer processors of a remote server and/or an autonomous vehicle may execute computer-executable instructions stored on memory to stop at the location of interest. For example, the autonomous vehicle may stop at a designated point. The autonomous vehicle may park at the designated point. The designated point may be a driveway, parking lot, side street, etc.

At block 306 of the process flow 300, one or more computer processors of a remote server and/or an autonomous vehicle may execute computer-executable instructions stored on memory to present user options and/or data. For example, data for presentation may include information on the property and/or neighborhood. Options may include allowing the user to indicate whether the user would like to leave the vehicle to see the property, and if so, whether the user would like the vehicle to wait for the user. If the user would like the vehicle to wait, follow-up prompts may include a length of time the user would like the vehicle to wait. Data and/or options may be presented at a display of the vehicle or at the user device of the user, or both.

At block 308 of the process flow 300, one or more computer processors of a remote server and/or an autonomous vehicle may execute computer-executable instructions stored on memory to receive user input. For example, the user may make selections of the various prompts presented to the user at the vehicle and/or user device. The selections or inputs may be used to determine whether the vehicle will wait at the property, participate in ridesharing or otherwise pick up other passengers, and so forth. User inputs may be made via gesture, touch, audio input, etc., and may be made at the vehicle or via user device that communicates, such as via Bluetooth, such input to the vehicle.

At block 310 of the process flow 300, one or more computer processors of a remote server and/or an autonomous vehicle may execute computer-executable instructions stored on memory to determine that a first user has departed an autonomous vehicle. In one example, when the vehicle arrives at the real estate option location, the user may be prompted via the display at the vehicle and/or the user device as to whether the user would like to view the interior of the property or exit the vehicle. If the user indicates that the user would like to view the interior of the property and/or exit the vehicle, the user may subsequently be prompted as to a length of time the user will be gone. For example, the user may be able to input a length of time such as 10 minutes, 15 minutes, 20 minutes, and the like indicating how long the user would like to stay at the property. In other examples, sensors at the autonomous vehicle may be configured to detect that a vehicle door has been opened and closed, cameras of the autonomous vehicle may be used to determine that the cabin of the vehicle is empty, motion sensors of the user device may indicate that the user is walking, and the like may be used to determine, by the computer processor(s), that the user has departed the vehicle. The user may, for example, have left the vehicle to tour the property.

At block 312 of the process flow 300, one or more computer processors of a remote server and/or an autonomous vehicle may execute computer-executable instructions stored on memory to determine that the first user will return to the autonomous vehicle after a length of time. For example, the user may indicate (responsive to a prompt as discussed above) that the user would like to view the property for 20 minutes. The computer processor(s) may therefore determine that the user will be gone for the 20 minute time period, and that the user will return after a length of time of 20 minutes. In some embodiments, the user may be able to request, using the display of the vehicle and/or the user's device, that the vehicle remain in a waiting mode for the user while the user is gone.

At block 314 of the process flow 300, one or more computer processors of a remote server and/or an autonomous vehicle may execute computer-executable instructions stored on memory to determine that a second user has requested an autonomous vehicle ride. For example, the computer processor(s) may receive a request for an autonomous vehicle ride from another user while the first user is viewing the property. The second user may request an autonomous vehicle ride using their own user device and may indicate a pick up and drop off location.

At block 316 of the process flow 300, one or more computer processors of a remote server and/or an autonomous vehicle may execute computer-executable instructions stored on memory to determine that the autonomous vehicle ride can be completed within the length of time. For example, based at least in part on the pickup and drop off location for the second user (as well as the time to drive to the pickup location, traffic information, etc.), the computer processor(s) may determine that a total time for the autonomous vehicle that is in the waiting mode to pick up and drop off the second user, and then return to the location of the first real estate option is less than the length of time that the first user will be gone (e.g., 20 minutes in this example). Accordingly, the computer processor(s) may determine that the autonomous vehicle can be used to complete the trip for the second user while the first user is touring the property. If the ride cannot be completed within the length of time, the vehicle may remain in a waiting mode at the property.

At block 318 of the process flow 300, one or more computer processors of a remote server and/or an autonomous vehicle may execute computer-executable instructions stored on memory to cause the autonomous vehicle to complete the autonomous vehicle ride. Accordingly, the autonomous vehicle may be caused to leave the first real estate option location, drive to the pickup location for the second user, complete the trip, and optionally return to the first real estate option location.

At optional block 320 of the process flow 300, one or more computer processors of a remote server and/or an autonomous vehicle may execute computer-executable instructions stored on memory to cause the autonomous vehicle to return to pick up the first user. In some instances, the autonomous vehicle may be caused to return to the first real estate option location after completing the trip for the second user. In other instances, such as if there is a delay associated with the second trip, the computer processor(s) of one or more servers may send a command to a different autonomous vehicle to pick up the first user from the first real estate option location at the end of the length of time. For example, the computer processor(s) may select a new autonomous vehicle of the same size and/or capacity of the original autonomous vehicle, and/or with a comparable range and having a time to arrive at the first property before the length of time elapses. The computer processor(s) may send route data and user data (e.g., for identification of the first user) to the new autonomous vehicle. As a result, the first user may not be delayed when resuming the neighborhood tour.

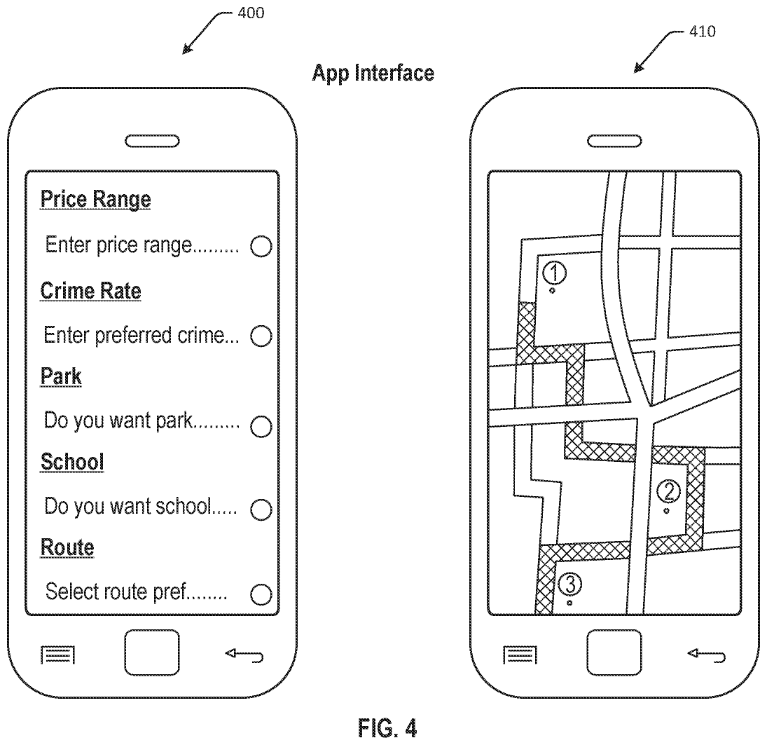

FIG. 4 are schematic illustrations of example user interfaces for smart neighborhood routing for autonomous vehicles in accordance with one or more embodiments of the disclosure. Although illustrated as user device user interfaces, in some embodiments, user interfaces may be presented at a display of an autonomous vehicle. The content for display may be sent to the autonomous vehicle and/or user device by one or more remote servers, such as that illustrated in FIG. 8, for presentation to the user.

At a first user interface 400, a user may make one or more selections or inputs that can be used to determine a route for the user. For example, the user may input properties of interest, user preferences, price range, crime rate, and so forth. Such information may be used to generate a set of candidate real estate options, and the user may select properties for viewing. The user may further input a starting and/or ending location for the real estate tour.

The route preferences may be the type of roads traveled on such as city roads, country roads, highways, and combinations thereof. The user may specify a desired pavement type such as paved or dirt. The user may also select to avoid toll roads and input regarding traffic congestion. The user may specify the types of areas to be explored during the tour. For example, the user could select nature to explore rural areas, enter city to explore downtown areas, or residential to explore those areas. The user need not provide input to all prompts.

In addition to generating a route for the selected real estate properties, the computer processor(s) of one or more servers or the autonomous vehicle may generate a neighborhood tour routing. For example, the computer processor(s) may determine a first location of interest within a predetermined distance of the first location of the first real estate property. The first location of interest may be, for example, one or more of: a playground, a park, a school, a hospital, and/or a shopping plaza. The computer processor(s) may determine a second location of interest within the predetermined distance, and may determine the neighborhood tour routing using the first location, the first location of interest, and a second location of interest. For example, as illustrated at a second user interface 410, the routing may include not only the selected properties, but locations of interest as well.

In some embodiments, routing may be determined using map data that includes, but is not limited to, streets, addresses, business, attractions, and the like. The map data be pulled from a remote server operated by a map service provider via a network such as the internet. The generated route may include the origin, the end destination (which may be the origin), and/or the roads to be traveled on to navigate between the origin and the end destination. The route may be composed of a series of interconnected segments. The refinement of the segments may vary. For example, the segments may be defined between vehicle action points. An action point may be the origin, turns, intermediate stops, and the final destination. For example, the portion of the route between the origin and the first turn is the first segment, etc. In other embodiments, the segments may be defined between adjacent intersections.

Some or each of the segments may be assigned attribute data used by the computer processor(s) for characterizing the segment to create a route tuned to the user's preferences. The attribute data may include average speed limit, crime-rate index, city-highway index, Cartesian orientation, road-surface type. The crime-rate index may be based on the received crime-rate data and represented by a number scale such as zero through five with five being the highest crime rate. The city-highway index may also be represented on a number scale such as zero through five with zero being a very rural road and five being a very urban road. The Cartesian orientation is the general direction of the road such as north-south. The road surface may be characterized as paved or dirt.

After the route is generated, the vehicle is autonomously driven along the route. The controller of the vehicle is programmed with the driving constraints of the vehicle, such as turning radius, vehicle dimensions, ground clearance, and the like. Using the vehicle constraints, the current environmental conditions sensed by the vision system, and the route, the controller generates steering, braking, and/or propulsion commands for operating the vehicle to drive along the route.

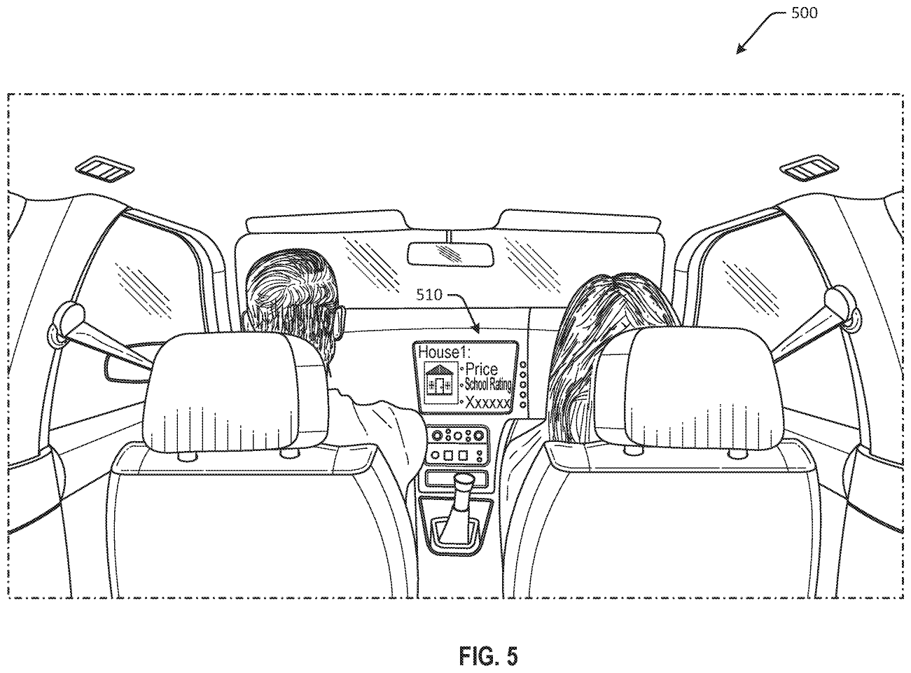

FIG. 5 is a schematic illustration of an example implementation 500 of presentation of relevant local information in accordance with one or more embodiments of the disclosure.

In the example of FIG. 5, relevant information for a property and/or location of interest or neighborhood may be presented via a display 510 of an autonomous vehicle and/or a user device. For example, relevant events that occur near a first location may be determined and presented to the user.

Referring to FIG. 6, an example autonomous vehicle 600 (which may correspond to the autonomous vehicle 110 of FIGS. 1A-1C) includes a powerplant 602 (such as a combustion engine and/or an electric motor) that provides torque to driven wheels 604 that propel the vehicle forward or backward.

Autonomous vehicle operation, including propulsion, steering, braking, navigation, and the like, may be controlled autonomously by a vehicle controller 606. For example, the vehicle controller 606 may be configured to receive feedback from one or more sensors (e.g., sensor system 634, etc.) and other vehicle components to determine road conditions, vehicle positioning, and so forth. The vehicle controller 606 may also ingest data form speed monitor and yaw sensor, as well as the tires, brakes, motor, and other vehicle components. The vehicle controller 606 may use the feedback and route/map data of the route to determine actions to be taken by the autonomous vehicle, which may include operations related to the engine, steering, braking, and so forth. Control of the various vehicle systems may be implemented using any suitable mechanical means, such as servo motors, robotic arms (e.g., to control steering wheel operation, acceleration pedal, brake pedal, etc.), and so forth. The controller 606 may be configured to process the route data for a neighborhood tour, and may be configured to interact with the user via the user interface devices in the car and/or by communicating with the user's user device.

The vehicle controller 606 may include one or more computer processors coupled to at least one memory. The vehicle 600 may include a braking system 608 having disks 610 and calipers 612. The vehicle 600 may include a steering system 614. The steering system 614 may include a steering wheel 616, a steering shaft 618 interconnecting the steering wheel to a steering rack 620 (or steering box). The front and/or rear wheels 604 may be connected to the steering rack 620 via axle 622. A steering sensor 624 may be disposed proximate the steering shaft 618 to measure a steering angle. The vehicle 600 also includes a speed sensor 626 that may be disposed at the wheels 604 or in the transmission. The speed sensor 626 is configured to output a signal to the controller 606 indicating the speed of the vehicle. A yaw sensor 628 is in communication with the controller 606 and is configured to output a signal indicating the yaw of the vehicle 600.

The vehicle 600 includes a cabin having a display 630 in electronic communication with the controller 606. The display 630 may be a touchscreen that displays information to the passengers of the vehicle and/or functions as an input, such as whether or not the rider is authenticated. A person having ordinary skill in the art will appreciate that many different display and input devices are available and that the present disclosure is not limited to any particular display. An audio system 632 may be disposed within the cabin and may include one or more speakers for providing information and entertainment to the driver and/or passengers. The audio system 632 may also include a microphone for receiving voice inputs. The vehicle may include a communications system 636 that is configured to send and/or receive wireless communications via one or more networks. The communications system 636 may be configured for communication with devices in the car or outside the car, such as a user's device, other vehicles, etc.

The vehicle 600 may also include a sensor system for sensing areas external to the vehicle. The vision system may include a plurality of different types of sensors and devices such as cameras, ultrasonic sensors, RADAR, LIDAR, and/or combinations thereof. The vision system may be in electronic communication with the controller 606 for controlling the functions of various components. The controller may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers and/or computer processors. The controller 606 may receive signals from the vision system 634 and may include memory containing machine-readable instructions for processing the data from the vision system. The controller 606 may be programmed to output instructions to at least the display 630, the audio system 632, the steering system 624, the braking system 608, and/or the powerplant 602 to autonomously operate the vehicle 600.

FIG. 7 is a schematic illustration of an example server architecture for one or more server(s) 700 in accordance with one or more embodiments of the disclosure. The server 700 illustrated in the example of FIG. 7 may correspond to a computer system configured to implement the functionality discussed with respect to FIGS. 1A-5. Some or all of the individual components may be optional and/or different in various embodiments. In some embodiments, the server 700 illustrated in FIG. 7 may be located at an autonomous vehicle 740. For example, some or all or the hardware and functionality of server 700 may be provided by the autonomous vehicle 740. The server 700 may be in communication with the autonomous vehicle 740, as well as one or more third party servers 744 (e.g., real estate listing servers that store real estate data, map data servers, etc.), and one or more user devices 750. The autonomous vehicle 740 may be in communication with the user device 750. The autonomous vehicle 740 may be in communication with the user device 750.

The server 700, the third party server 744, the autonomous vehicle 740, and/or the user device 750 may be configured to communicate via one or more networks 742. The autonomous vehicle 740 may additionally be in wireless communication 746 with the user device 750 via a connection protocol such as Bluetooth or Near Field Communication. The server 700 may be configured to communicate via one or more networks 742. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display components 714, one or more optional camera(s)/microphone(s) 716, and data storage 720. The server 700 may further include one or more bus(es) 718 that functionally couple various components of the server 700. The server 700 may further include one or more antenna(e) 730 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the server 700. The bus(es) 718 may include, without limitation, a memory bus or a memory controller, a peripheral bus, an accelerated graphics port, and so forth. The bus(es) 718 may be associated with any suitable bus architecture.

The memory 704 of the server 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

The data storage 720 may include removable storage and/or non-removable storage including, but not limited to, magnetic storage, optical disk storage, and/or tape storage. The data storage 720 may provide non-volatile storage of computer-executable instructions and other data.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. More specifically, the data storage 720 may store one or more operating systems (O/S) 722; one or more database management systems (DBMS) 724; and one or more program module(s), applications, engines, computer-executable code, scripts, or the like such as, for example, one or more routing module(s) 726 and/or one or more driving module(s) 728. Some or all of these module(s) may be sub-module(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The processor(s) 702 may be configured to access the memory 704 and execute the computer-executable instructions loaded therein. For example, the processor(s) 702 may be configured to execute the computer-executable instructions of the various program module(s), applications, engines, or the like of the server 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit.

Referring now to functionality supported by the various program module(s) depicted in FIG. 7, the routing module(s) 726 may include computer-executable instructions, code, or the like that responsive to execution by one or more of the processor(s) 702 may perform one or more blocks of the process flow 200 and process flow 300 and/or functions including, but not limited to, determine points of interest, determine historical user selections or preferences, determine roam radiuses, determine optimal routing, determine real-time traffic data, determine suggested routing options, send and receive data, control autonomous vehicle features, and the like.

The routing module 726 may be in communication with the autonomous vehicle 740, third party server 744, user device 750, and/or other components. For example, the routing module may send route data to the autonomous vehicle 740, receive real estate listing data from the third party server 744, receive user selections of real estate from the user device 750, and so forth.

The driving module(s) 728 may include computer-executable instructions, code, or the like that responsive to execution by one or more of the processor(s) 702 may perform functions including, but not limited to, sending and/or receiving data, determining whether a user has left or entered an autonomous vehicle, determining whether an autonomous vehicle should wait for a user, determining whether a user is in proximity to a vehicle, and the like. In some embodiments, the driving module 728 may be partially or wholly integral to the autonomous vehicle 740.

The driving module 728 may be in communication with the autonomous vehicle 740, third party server 744, user device 750, and/or other components. For example, the driving module may send traffic data or ride requests to the autonomous vehicle 740, receive road condition data from the third party server 744, receive user selections of route preferences from the user device 750, and so forth.

Referring now to other illustrative components depicted as being stored in the data storage 720, the 0/S 722 may be loaded from the data storage 720 into the memory 704 and may provide an interface between other application software executing on the server 700 and the hardware resources of the server 700.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages.

Referring now to other illustrative components of the server 700, the input/output (I/O) interface(s) 706 may facilitate the receipt of input information by the server 700 from one or more I/O devices as well as the output of information from the server 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 706 may also include a connection to one or more of the antenna(e) 730 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The server 700 may further include one or more network interface(s) 708 via which the server 700 may communicate with any of a variety of other systems, platforms, networks, devices, and so forth. The network interface(s) 708 may enable communication, for example, with one or more wireless routers, one or more host servers, one or more web servers, and the like via one or more networks.

The sensor(s)/sensor interface(s) 710 may include or may be capable of interfacing with any suitable type of sensing device such as, for example, inertial sensors, force sensors, thermal sensors, photocells, and so forth.

The display component(s) 714 may include one or more display layers, such as LED or LCD layers, touch screen layers, protective layers, and/or other layers. The optional camera(s) 716 may be any device configured to capture ambient light or images. The optional microphone(s) 716 may be any device configured to receive analog sound input or voice data. The microphone(s) 716 may include microphones used to capture sound.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module.

It should further be appreciated that the server 700 may include alternate and/or additional hardware, software, or firmware components beyond those described or depicted without departing from the scope of the disclosure.

The user device 750 may include one or more computer processor(s) 752, one or more memory devices 754, and one or more applications, such as an autonomous vehicle application 756. Other embodiments may include different components.

The processor(s) 752 may be configured to access the memory 754 and execute the computer-executable instructions loaded therein. For example, the processor(s) 752 may be configured to execute the computer-executable instructions of the various program module(s), applications, engines, or the like of the device to cause or facilitate various operations to be performed in accordance with one or more embodiments of the disclosure. The processor(s) 752 may include any suitable processing unit capable of accepting data as input, processing the input data in accordance with stored computer-executable instructions, and generating output data. The processor(s) 752 may include any type of suitable processing unit.

The memory 754 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 750, the autonomous vehicle application 756 may be a mobile application executable by the processor 752 that can be used to present options and/or receive user inputs of information related to autonomous vehicle ride requests, real estate option presentation and selection, neighborhood tour content, ride scheduling, and the like.

The autonomous vehicle 740 may include one or more computer processor(s) 760, one or more memory devices 762, one or more sensors 764, and one or more applications, such as an autonomous driving application 766. Other embodiments may include different components. A combination or sub combination of these components may be integral to the controller 606 in FIG. 6.

The processor(s) 760 may be configured to access the memory 762 and execute the computer-executable instructions loaded therein. For example, the processor(s) 760 may be configured to execute the computer-executable instructions of the various program module(s), applications, engines, or the like of the device to cause or facilitate various operations to be performed in accordance with one or more embodiments of the disclosure. The processor(s) 760 may include any suitable processing unit capable of accepting data as input, processing the input data in accordance with stored computer-executable instructions, and generating output data. The processor(s) 760 may include any type of suitable processing unit.

The memory 762 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 740, the autonomous vehicle application 766 may be a mobile application executable by the processor 760 that can be used to receive data from the sensors 764, receive and execute neighborhood tour data, and/or control operation of the autonomous vehicle 740.

One or more operations of the methods, process flows, and use cases of FIGS. 1A-7 may be performed by a device having the illustrative configuration depicted in FIG. 7, or more specifically, by one or more engines, program module(s), applications, or the like executable on such a device. It should be appreciated, however, that such operations may be implemented in connection with numerous other device configurations.

The operations described and depicted in the illustrative methods and process flows of FIGS. 1A-7 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1A-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Example embodiments of the disclosure may include one or more of the following examples:

Example 1 may include an autonomous vehicle comprising: at least one memory comprising computer-executable instructions; and one or more computer processors configured to access the at least one memory and execute the computer-executable instructions to: determine a first set of inputs indicative of real estate locations; determine a set of real estate options based at least in part on the first set of inputs, the set of real estate options comprising a first real estate option; determine that the first real estate option is selected for viewing by a user; and determine a route from a first location to a second location, the second location associated with the first real estate option, wherein the route includes at least one stopping point.

Example 2 may include the autonomous vehicle of example 1 and/or some other example herein, wherein the one or more computer processors are further configured to access the at least one memory to: request data corresponding to the real estate locations; receive the data, wherein the data comprises the first location and the second location; and cause the autonomous vehicle to drive from the first location to the second location, wherein the at least one stopping point is at the second location.

Example 3 may include the autonomous vehicle of example 1 and/or some other example herein, wherein the one or more computer processors are further configured to access the at least one memory to: determine that the user is interested in a neighborhood associated with the second location; generate a neighborhood tour route for the neighborhood; and cause an autonomous vehicle to drive at least a portion of the neighborhood tour route.

Example 4 may include the autonomous vehicle of example 3 and/or some other example herein, wherein the one or more computer processors are configured to generate the neighborhood tour routing for the neighborhood by executing the computer-executable instructions to: determine a first location of interest within a distance of the second location; determine a second location of interest within the distance; and determine the neighborhood tour route using the second location, the first location of interest, and a second location of interest, wherein the at least one stopping point includes the first location of interest.

Example 5 may include the autonomous vehicle of example 4 and/or some other example herein, wherein the first location of interest is one of: a playground, a park, a school, a hospital, or a shopping plaza.

Example 6 may include the autonomous vehicle of example 1 and/or some other example herein, wherein the one or more computer processors are further configured to access the at least one memory to: determine that the autonomous vehicle is within a distance of the second location; and automatically send a message to a real estate service device requesting access to the first real estate option.

Example 7 may include the autonomous vehicle of example 6 and/or some other example herein, wherein the one or more computer processors are further configured to access the at least one memory to: determine that the user has departed an autonomous vehicle at the second location; determine a time period before the user will return to the autonomous vehicle; and cause the autonomous vehicle to initiate a ridesharing mode during the time period.

Example 8 may include the autonomous vehicle of example 6 and/or some other example herein, wherein the one or more computer processors are further configured to access the at least one memory to: determine that the user has departed the autonomous vehicle at the first location; determine that the user will return to the autonomous vehicle within a length of time; and cause the autonomous vehicle to remain within a predetermined distance of the first location for the length of time.

Example 9 may include the autonomous vehicle of example 1 and/or some other example herein, wherein the one or more computer processors are further configured to access the at least one memory to: determine content associated with the second location; and cause presentation of the content to the user.

Example 10 may include the autonomous vehicle of example 1 and/or some other example herein, wherein the one or more computer processors are further configured to access the at least one memory to: determine that the autonomous vehicle is at the second location; determine that the user has departed the autonomous vehicle; determine a third location of a user device associated with the user; and cause an autonomous vehicle to drive to the location.

Example 11 may include a method comprising: determining, by one or more computer processors coupled to at least one memory, a first set of inputs indicative of real estate locations; determining a set of real estate options based at least in part on the first set of inputs, the set of real estate options comprising a first real estate option; determining that the first real estate option is selected for viewing by a user; and determining a route from a first location to a second location, the second location associated with the first real estate option, wherein the route includes at least one stopping point.

Example 12 may include the method of claim 11 and/or some other example herein, further comprising: requesting data corresponding to the real estate locations; receiving the data, wherein the data comprises the first location and the second location; and causing the autonomous vehicle to drive from the first location to the second location, wherein the at least one stopping point is at the second location.

Example 13 may include the method of claim 11 and/or some other example herein, further comprising: determining that the user is interested in a neighborhood associated with the second location; generating a neighborhood tour route for the neighborhood; and causing an autonomous vehicle to drive at least a portion of the neighborhood tour route.

Example 14 may include the method of claim 13 and/or some other example herein, wherein generating the neighborhood tour routing for the neighborhood comprises: determining a first location of interest within a distance of the second location; determining a second location of interest within the distance; and determining the neighborhood tour route using the second location, the first location of interest, and a second location of interest, wherein the at least one stopping point includes the first location of interest.

Example 15 may include the method of claim 11 and/or some other example herein, further comprising: determining that the autonomous vehicle is within a distance of the second location; and automatically sending a message to a real estate service device requesting access to the first real estate option.

Example 16 may include the method of claim 15 and/or some other example herein, further comprising: determining that the user has departed an autonomous vehicle at the second location; determining a time period before the user will return to the autonomous vehicle; and causing the autonomous vehicle to initiate a ridesharing mode during the time period.

Example 17 may include the method of claim 15 and/or some other example herein, further comprising: determining that the user has departed the autonomous vehicle at the first location; determining that the user will return to the autonomous vehicle within a length of time; and causing the autonomous vehicle to remain within a predetermined distance of the first location for the length of time.

Example 18 may include the method of claim 11 and/or some other example herein, further comprising: determining relevant events that occur near the first location; and causing presentation of the relevant events to the user.

Example 19 may include the method of claim 11 and/or some other example herein, further comprising: determining the current location of the user; and causing an autonomous vehicle to drive to the current location to pick up the user.

Example 20 may include a method comprising: determining, by an autonomous vehicle, a first set of inputs indicative of desired real estate locations for a real estate tour; determining a set of real estate options based at least in part on the first set of inputs, the set of real estate options comprising a first real estate option and a second real estate option; determining that the first real estate option and the second real estate option are selected for viewing by a user; determining a route from a first location to a second location of the first real estate option; autonomously driving from the first location to the second location; autonomously driving, after a determined period of time at the second location, from the second location to a third location of the second real estate option.

Example 21 may include the method of claim 20 and/or some other example herein, further comprising: determining content associated with the second location; and causing presentation of the content to the user.

Example 22 may include the method of claim 20 and/or some other example herein, further comprising: determining that the autonomous vehicle is at the second location; determining that the user has departed the autonomous vehicle; determining a third location of a user device associated with the user; and causing an autonomous vehicle to drive to the location.

Example 23 may include means for determining a first set of inputs indicative of real estate locations; means for determining a set of real estate options based at least in part on the first set of inputs, the set of real estate options comprising a first real estate option; means for determining that the first real estate option is selected for viewing by a user; and means for determining a route from a first location to a second location, the second location associated with the first real estate option, wherein the route includes at least one stopping point.

Example 24 may include means for determining a first set of inputs indicative of desired real estate locations for a real estate tour; means for determining a set of real estate options based at least in part on the first set of inputs, the set of real estate options comprising a first real estate option and a second real estate option; means for determining that the first real estate option and the second real estate option are selected for viewing by a user; means for determining a route from a first location to a second location of the first real estate option; autonomously driving from the first location to the second location; and autonomously driving, after a determined period of time at the second location, from the second location to a third location of the second real estate option.

What is claimed is:

1. An autonomous vehicle comprising:
at least one memory comprising computer-executable instructions; and
one or more computer processors configured to access the at least one memory and execute the computer-executable instructions to:
determine a first set of inputs indicative of real estate locations;
determine a set of real estate options based at least in part on the first set of inputs, the set of real estate options comprising a first real estate option;
determine that the first real estate option is selected for viewing by a user; and
determine a route from a first location to a second location, the second location associated with the first real estate option, wherein the route includes at least one stopping point.

2. The autonomous vehicle of claim 1, wherein the one or more computer processors are further configured to access the at least one memory to:
request data corresponding to the real estate locations;
receive the data, wherein the data comprises the first location and the second location; and
cause the autonomous vehicle to drive from the first location to the second location, wherein the at least one stopping point is at the second location.

3. The autonomous vehicle of claim 1, wherein the one or more computer processors are further configured to access the at least one memory to:
determine that the user is interested in a neighborhood associated with the second location;
generate a neighborhood tour route for the neighborhood; and
cause an autonomous vehicle to drive at least a portion of the neighborhood tour route.

4. The autonomous vehicle of claim 1 wherein the one or more computer processors are configured to generate the neighborhood tour route for the neighborhood by executing the computer-executable instructions to:
determine a first location of interest within a distance of the second location;
determine a second location of interest within the distance; and
determine the neighborhood tour route using the second location, the first location of interest, and a second location of interest, wherein the at least one stopping point includes the first location of interest.

5. The autonomous vehicle of claim 4, wherein the first location of interest is one of: a playground, a park, a school, a hospital, or a shopping plaza.

6. The autonomous vehicle of claim 1, wherein the one or more computer processors are further configured to access the at least one memory to:
determine that the autonomous vehicle is within a distance of the second location; and
automatically send a message to a real estate service device requesting access to the first real estate option.

7. The autonomous vehicle of claim 1, wherein the one or more computer processors are further configured to access the at least one memory to:
determine that the user has departed an autonomous vehicle at the second location;
determine a time period before the user will return to the autonomous vehicle; and
cause the autonomous vehicle to initiate a ridesharing mode during the time period.

8. The autonomous vehicle of claim 1, wherein the one or more computer processors are further configured to access the at least one memory to:
determine that the user has departed the autonomous vehicle at the first location;
determine that the user will return to the autonomous vehicle within a length of time; and
cause the autonomous vehicle to remain within a predetermined distance of the first location for the length of time.

9. The autonomous vehicle of claim 1, wherein the one or more computer processors are further configured to access the at least one memory to:
determine content associated with the second location; and
cause presentation of the content to the user.

10. The autonomous vehicle of claim 1, wherein the one or more computer processors are further configured to access the at least one memory to:
determine that the autonomous vehicle is at the second location;
determine that the user has departed the autonomous vehicle;
determine a third location of a user device associated with the user; and
cause an autonomous vehicle to drive to the location.

11. A method comprising:
determining, by one or more computer processors coupled to at least one memory, a first set of inputs indicative of real estate locations;
determining a set of real estate options based at least in part on the first set of inputs, the set of real estate options comprising a first real estate option;
determining that the first real estate option is selected for viewing by a user; and
determining a route from a first location to a second location, the second location associated with the first real estate option, wherein the route includes at least one stopping point.

12. The method of claim 11, further comprising:
requesting data corresponding to the real estate locations;
receiving the data, wherein the data comprises the first location and the second location; and
causing the autonomous vehicle to drive from the first location to the second location, wherein the at least one stopping point is at the second location.

13. The method of claim 11, further comprising:
determining that the user is interested in a neighborhood associated with the second location;
generating a neighborhood tour route for the neighborhood; and
causing an autonomous vehicle to drive at least a portion of the neighborhood tour route.

14. The method of claim 11, wherein generating the neighborhood tour routing for the neighborhood comprises:
determining a first location of interest within a distance of the second location;
determining a second location of interest within the distance; and
determining the neighborhood tour route using the second location, the first location of interest, and a second location of interest, wherein the at least one stopping point includes the first location of interest.

15. The method of claim 11, further comprising:
determining that the autonomous vehicle is within a distance of the second location; and
automatically sending a message to a real estate service device requesting access to the first real estate option.

16. The method of claim 11, further comprising:
determining that the user has departed an autonomous vehicle at the second location;
determining a time period before the user will return to the autonomous vehicle; and
causing the autonomous vehicle to initiate a ridesharing mode during the time period.

17. The method of claim 11, further comprising:
determining that the user has departed the autonomous vehicle at the first location;
determining that the user will return to the autonomous vehicle within a length of time; and
causing the autonomous vehicle to remain within a predetermined distance of the first location for the length of time.

18. A method comprising:
determining, by an autonomous vehicle, a first set of inputs indicative of desired real estate locations for a real estate tour;
determining a set of real estate options based at least in part on the first set of inputs, the set of real estate options comprising a first real estate option and a second real estate option;
determining that the first real estate option and the second real estate option are selected for viewing by a user;
determining a route from a first location to a second location of the first real estate option;
autonomously driving from the first location to the second location; and
autonomously driving, after a determined period of time at the second location, from the second location to a third location of the second real estate option.

19. The method of claim 18, further comprising:
determining content associated with the second location; and
causing presentation of the content to the user.

20. The method of claim 18, further comprising:
determining that the autonomous vehicle is at the second location;
determining that the user has departed the autonomous vehicle;
determining a third location of a user device associated with the user; and
causing an autonomous vehicle to drive to the location.
